(19) United States
(12) Patent Application Publication
(10) Pub. No.: US 2005/0084134 A1
(43) Pub. Date: Apr. 21, 2005

(54) License plate recognition

(76) Inventor: Sorin M. Toda, Richmond Hill (CA)

Correspondence Address: BARNES & THORNBURG, 11 SOUTH MERIDIAN, INDIANAPOLIS, IN, 46204, US

(21) Appl. No.: 10/966,622

(22) Filed: Oct. 15, 2004

Related U.S. Application Data
(60) Provisional application No. 60/511,708, filed on Oct. 17, 2003.

(51) Int. Cl. G06K 9/00

(52) U.S. Cl. 382/105

(57) ABSTRACT

A method for obtaining a license plate number for use in a system that images a license plate and converts a license plate number in the license plate image to text includes substituting at least one voice derived character in the text. A method of matching a license plate number includes receiving a license plate number, receiving a confidence level indicator, comparing the received license plate number with license plate numbers in a list, and where a number of alphanumeric characters of the received license plate number match characters of a license plate number in the search list such that the percentage of characters matched exceeds the confidence level, declaring a match.

### CROSS-REFERENCE TO RELATED APPLICATION

This application claims priority from U.S. provisional patent application No. 60/511,708 filed Oct. 17, 2003.

### BACKGROUND OF THE INVENTION

This invention relates to a system and method for recognizing license plates.

When police are interested in a vehicle they may wish to report the license plate to determine whether the vehicle may be known to be associated with a criminal activity (for example, a stolen vehicle). To do so, a police officer may orally dictate the license plate number to a base station and await for an oral response. More modem systems allow an officer to key in the license plate number to a data system which system responds with information, if any, on the vehicle registered to that license plate number.

These systems may be difficult for a police officer to manage in some circumstances, such as when in pursuit of a vehicle.

### SUMMARY OF INVENTION

A visual image of a license plate is captured by a camera and the license plate number converted to textual form. Voice input may be used to modify the resultant text. The derived text is considered to be an input license plate number which may be compared against a search list. In one embodiment, the percentage of alphanumeric characters in the input license plate number that must match a given license plate number in the search list in order for a match to be declared with that license plate number in the search list may be set. This sets a confidence level for the match.

Other features and advantages of the invention will become apparent by reference to the subsequent description in conjunction with the drawings.

### BRIEF DESCRIPTION OF THE DRAWINGS

In the figures which illustrate example embodiments of the invention,

FIG. 1 is a block diagram of the system made in accordance with this invention,

FIG. 2 is a flow diagram illustrating the operation of FIG. 1,

FIG. 3 is a block diagram of the system made in accordance with another embodiment of this invention.

### DETAILED DESCRIPTION

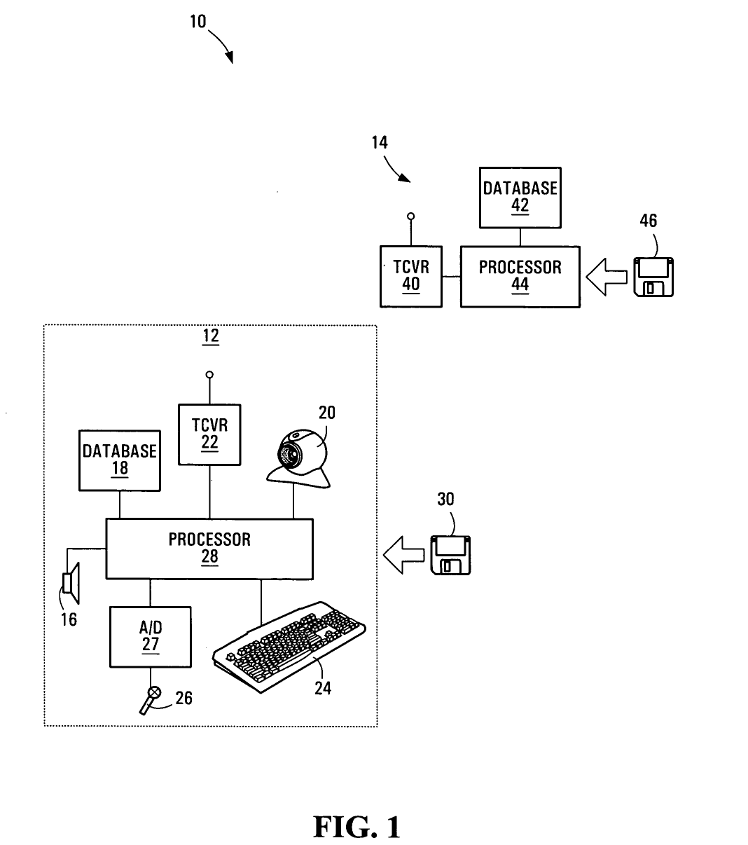

Referencing FIG. 1 a system 10 made in accordance with this invention comprises a mobile station 12, which may be a police vehicle, and a base station 14. The mobile station has a speaker 16, database 18, camera 20, transceiver 22, keyboard 24, and microphone 26 all connected to a processor 28. The processor 28 may be configured to operate in accordance with this invention with computer readable instructions loaded from a computer readable media 30 which may be, for example, a computer readable disc, memory chip, or a file downloaded from a remote source.

The base station 14 comprises a transceiver 40 and database 42 connected to a processor 44 which is configured to operate in accordance with this invention with computer instructions read from a computer readable media 46.

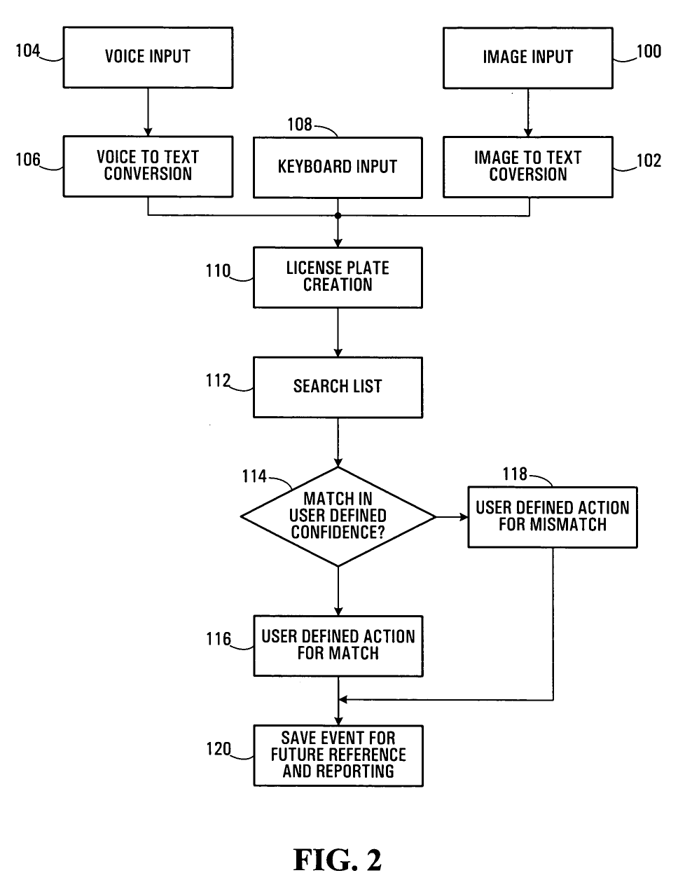

With reference to FIG. 2 along with FIG. 1, in operation, an image of a license plate of a car may be captured by camera 20 (block 100). This image is digitized by the camera and passed to the processor 28 where it inputs an image-to-text conversion module such that the alphanumeric characters in the image are converted to text (that is, the alphanumeric characters are recognised) in any known manner (block 102). For example, the image-to-text conversion module may use neural-fuzzy logic. The first part of the module may be dedicated to learning new characters, or correcting/adding already known ones. The user is responsible for teaching the system by inputting different license plates images which are well defined—that is, the user must correlate the characters and the layout of the plate within each image. This builds a system of fuzzy sets according to each character used so that each character will be represented in the system by a fuzzy set rather that a single-specific-crisp character. The second part may be a real time classifier which is based on Fuzzy K-Nearest Neighbor Algorithm which is a simple, stabile and easy to implement classifier system. This uses the fuzzy sets built in the learning phase. This gives the possibility for the system to output a set (list) of license plates which are close enough (a user defined parameter) to the one detected in the real time. The user can visually inspect the whole set and decide which one is the best correlated with the detected one. Exemplary approaches for fuzzy systems are described in James M. Keller, Michael R. Gray, and James A. Givens, Jr.: A Fuzzy K-Nearest Neighbor Algorithm. Fuzzy Models For Pattern Recognition, IEEE Press, 1992, the contents of which are incorporated herein by reference. Exemplary approaches for neural systems are described in Richard P. Lippmann: An Introduction to Computing with Neural Nets. Fuzzy Models for Pattern Recognition, IEEE Press, 1992, the contents of which are incorporated by reference herein. The processor may also receive digitized voice from microphone 26 through analog to digital converter 27 (block 104). Any such voice input is converted to text by a voice to text conversion engine which is part of processor 28 (block 106). Any suitable voice to text conversion engine may be used. Finally, the processor may receive alphanumeric characters output from keyboard 24 (block 108).

The processor creates a license plate number from the up to three inputs as follows. Any keyboard input overrides the other inputs. Any voice input overrides text derived from the image input. The image input governs only where not overwritten by the other inputs. In this regard, an input overwriting the image input is considered to overwrite the licence plate number beginning at the first alphanumeric character. Thus, if, for example, there is no keyboard input but three characters of a license plate have been entered through a voice input then the license plate number created by the processor will begin with the first three characters from the voice input followed by the remaining characters derived from the image input. Processor 28 may use a text-to-voice engine to announce the derived licence plate number over speaker 16. Additionally, or alternatively, there may be a monitor which displays the derived licence plate number. This feedback may be used by a user at the mobile station to verify the licence plate number.

The processor 28 then accesses the database 18 for a list of license plate numbers and compares the created license plate number with those in the list (block 112). A match will be declared depending upon a user defined confidence level (block 114). In such case, in advance of operation, an administrator for mobile station 12 may set a level of confidence based on the number of the alphanumeric characters in a license plate which must match one in a list for a match to be declared. For example, it may be that there are up to eight alphanumeric characters that make up any license plate number. Thus, there are eight character positions and each position may be occupied by a character or by a space. It may be decided that six of the eight must match a license plate number in the list in order for a match to be declared. (That is, the six characters must be the same as six characters in the listed license plate number and appear in the same order as these characters in the listed license plate number.) In such case the confidence level may be set at a level indicative of a requirement for six out of eight characters (and spaces) matching. Since six out of eight yields a 75% match rate and seven out of eight yields an 87½% match rate, the confidence level may be conveniently set at some percent between these limits, such as 80%. If a matching license plate number is found (to the defined level of confidence), a preset action may occur (block 116) as, for example, returning the matching license plate number in the database along with information associated with that license plate number. This information may include, for example, the make and model of the car thereby giving a user at the mobile station an opportunity to verify that the car for which the search was generated is indeed the car to which the returned information pertains. The information may also include information regarding criminal activity with which the car has been associated.

If there are plural matches, the processor may increase the confidence level and check for a unique match, or may output the plural matches to allow a user to select a unique match (through the keyboard or a voice input). If there is no match, then another user defined action may result (block 118) such as returning the license plate number received for the search query with an indication that there is no entry for that license plate number. In either event, these results may be logged for future reference and reporting (120).

Database 18 may be updated periodically by the processor 28 querying the base station 14 for an update. In such instance, processor 44 at the base station retrieves an updated list of licence plate numbers and associated information from database 42 and returns this data to the mobile station 12 via transceiver 40. Alternatively, the base station may be configured to broadcast an updated list whenever there are updates.

In an alternate embodiment, database 18 may be omitted and the mobile station may pass each created licence plate to the base station 14 for determination of whether there is a match. The drawback, however, with this approach is that it fails to function when the mobile station is out of range of the base station.

Optionally, through an appropriate instruction to processor 28, the voice or keyboard input, rather than overwriting a licence plate number created from a camera image, could be used to input a second licence plate number.

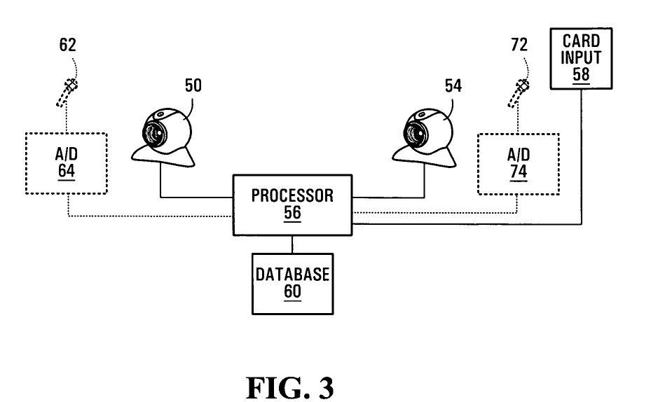

The invention may also be employed in gate control applications. For example, with reference to FIG. 3, a camera 50 may be installed at an entrance to a paid parking garage and a camera 54 installed at the exit of the same garage. Each camera may output to a processor 56. The processor may also accept the entry from a paid card input device 58 and from a database 60. Optionally, at either or both of the entrance and exit, a voice input comprising a microphone 62, 72, and an analog to digital converter 64, 74 may input to the processor 56.

In operation, when a car enters the garage, a digitized image of the license plate is passed from camera 50 to processor 56. Optionally, if the entrance is manned, the input license plate number may be modified by an input from the microphone 62 which is taken in priority to an image input. The license plate number is then stored by the processor in database 60. Subsequently, when that same car attempts to exit the parking garage, its license plate is imaged by camera 54. The imaged license plate number is then converted to text to the processor (modified by any voice input, if present) and the received license plate number is compared with all the license plate numbers in the database for a match. Again, a confidence level may be set by an administrator. In the parking lot example, a match should be expected. If no match is found, the system may reduce the confidence level and recheck for a match. If plural matches are found, the system may increase the confidence level and recheck for a match or, if the exit is manned, output the plural matches and allow the person at the exit to select from the list. Once a unique match is settled upon, the processor may compare the time the image was received from camera 50 to the time the image was received from camera 54 to determine an elapsed time. Based on this, a parking charge may be calculated and payment received from the driver through card input 58 whereupon the control access barrier for the exit may allow the car to exit.

The invention also has application for a gated community wherein the license plate numbers of all permitted vehicles will be stored in a database. When a vehicle approaches the gate, a camera takes an image of the license plate and this is compared with the list in the database to determine whether, to a desired level of confidence, there was a match. On a match, the gate is raised to allow access to the vehicle. Again, if a booth at the gate is manned, a licence plate number derived from the image may be overridden, as required.

Other modifications will be apparent to those skilled in the art and, therefore, the invention is defined in the claims.

1. A method for obtaining a license plate number for use in a system that images a licence plate and converts a license plate number in the license plate image to text, said method comprising:
substituting at least one voice derived character in said text.

2. The method of claim 1 further comprising converting said text to speech and announcing said text.

3. A method of matching a license plate number comprising:
receiving a license plate number;
receiving a confidence level indicator;
comparing said received license plate number with license plate numbers in a list;
where a number of alphanumeric characters of the received license plate number match characters of a license plate number in the search list such that the percentage of characters matched exceeds said confidence level, declaring a match.

4. The method of claim 3 wherein characters of the received license plate number are considered to match characters of a license late number in said search list only where said characters of said received license plate number appear in the same order as characters of said license plate number in said search list.

5. The method of claim 4 wherein said receiving a license plate number comprises receiving an initial licence plate number and substituting at least one voice derived character in said initial license plate number.

6. The method of claim 3 further comprising periodically updating said list from a remote source.
